(19) United States
(12) Patent Application Publication
(10) Pub. No.: US 2021/0193046 A1
(43) Pub. Date: Jun. 24, 2021

(54) PIXEL UNIT, DISPLAY PANEL AND ELECTRONIC DEVICE

(71) Applicant: SHENZHEN ROYOLE TECHNOLOGIES CO., LTD., Shenzhen (CN)

(72) Inventors: Shaowen WANG, Shenzhen (CN); Ze YUAN, Shenzhen (CN); Jiahao KANG, Shenzhen (CN)

(21) Appl. No.: 17/129,220

(22) Filed: Dec. 21, 2020

(30) Foreign Application Priority Data
Dec. 23, 2019 (CN) 201911341157.X

(51) Int. Cl. G09G 3/3258; G09G 3/3266; G09G 3/3291

(52) U.S. Cl. CPC G09G 3/3258; G09G 2300/0439; G09G 3/3291; G09G 3/3266

(57) ABSTRACT

The disclosure provides a pixel unit. The pixel unit includes a pixel circuit. The pixel circuit includes a data writing unit, a driving unit, a display unit, a compensation unit and a reset unit. The reset unit is electrically connected with at least one of the display unit and the driving unit. The reset unit is electrically connected with the scan drive line to receive a scan signal, and is operable to write, according to the reset signal, a scan voltage of the scan signal as the reset voltage into at least one of the display unit and the driving unit during a reset time period. The scan signal is the first scan signal or a first scan signal of a next pixel unit. The disclosure also provides a display panel and an electronic device.

### CROSS-REFERENCE TO RELATED APPLICATIONS

This application claims priority to Chinese Patent Application No. 201911341157X, filed on Dec. 23, 2019, the disclosure of which is hereby incorporated by reference in its entirety.

### TECHNICAL FIELD

The disclosure relates to the field of display driving, in particular to a pixel unit, a display panel, and an electronic device.

### BACKGROUND

During image display of a self-emitting display panel, it is necessary for a scanning driving circuit to provide a gate scan signal and a light emitting scan signal and for a data driving circuit to provide an image data signal, to drive a pixel unit array arranged in an image display area to perform the image display. Each pixel unit is required to receive a variety types of signals during the image display, including a light emitting signal, an image data signal, a scan signal, and a reset voltage signal for initializing voltages of a driving unit and a display unit. Each type of signals comes from one type of signal line, which results in dense wires and a low aperture ratio.

### SUMMARY

In view of this, a pixel unit which can reduce reset voltage lines is provided. Specific technical schemes are as follows.

A pixel unit includes a pixel circuit. The pixel circuit includes a data writing unit, a driving unit, a display unit, a compensation unit, and a reset unit.

The data writing unit is electrically connected with the driving unit and is operable to write image data into the driving unit according to a first scan signal during a data writing time period.

The driving unit is electrically connected with the display unit and is operable to provide, according to a received light emitting signal and the image data, a driving current to the display unit during a display time period, to drive the display unit for image display.

The compensation unit is electrically connected with the driving unit and is operable to provide a compensation voltage to the driving unit in advance when the image data is written into the driving unit, the compensation voltage being used for compensation of a voltage drift generated by the driving unit when the driving unit provides the driving current to the display unit.

The reset unit is electrically connected with at least one of the display unit and the driving unit and is operable to write, according to a reset signal, a reset voltage into an unit electrically connected with the reset unit during a reset time period, so that the unit connected with the reset unit is in a corresponding initial voltage state.

The reset unit is electrically connected with a scan drive line to receive a scan signal, and is operable to write, according to the reset signal, a scan voltage of the scan signal as the reset voltage into at least one of the display unit and the driving unit during the reset time period. The scan signal is the first scan signal or a first scan signal of a next pixel unit.

The present disclosure also provides a display panel which includes multiple pixel units according to the above, for performing an image display and located in a display area.

The disclosure also provides an electronic device which includes the display panel as described above.

The disclosure provides advantageous effects that: in the pixel unit provided in the disclosure, the reset unit is electrically connected with the scan drive line so as to write the scan voltage of the scan signal as the reset voltage into at least one of the display unit and the driving unit, so that a unit connected with the reset unit is in a corresponding initial voltage state, which reduces the reset voltage lines, thereby saving wiring space, improving an aperture ratio of the display panel, and making a bezel of the display panel narrower.

### BRIEF DESCRIPTION OF THE DRAWINGS

In order to describe technical solutions of embodiments more clearly, the following will give a brief description of accompanying drawings used for describing the embodiments. Apparently, accompanying drawings described below are merely some embodiments. Those of ordinary skill in the art can also obtain other accompanying drawings based on the accompanying drawings described below without creative efforts.

FIG. 1 is a circuit block diagram of a pixel unit provided in a first embodiment of the present disclosure.

FIG. 2 is a schematic circuit diagram of a pixel circuit of the pixel unit shown in FIG. 1.

FIG. 3 is a timing diagram of the pixel unit shown in FIG. 2 during displaying of a frame of an image.

FIG. 4 is a schematic diagram of a circuit operating state of the pixel unit shown in FIG. 2 during a reset time period.

FIG. 5 is a schematic diagram of a circuit operating state of the pixel unit shown in FIG. 2 during the data writing time period.

FIG. 6 is a schematic diagram of a circuit operating state of the pixel unit shown in FIG. 2 during the display time period.

FIG. 7 is a schematic circuit diagram of a pixel unit provided in a second embodiment of this disclosure.

FIG. 8 is a schematic circuit diagram of a pixel unit provided in a third embodiment of the present disclosure.

FIG. 9 is a schematic circuit diagram of a pixel unit according to a fourth embodiment of the present disclosure.

FIG. 10 is a schematic circuit diagram of a pixel unit provided in a fifth embodiment of this disclosure.

FIG. 11 is a timing diagram of the pixel circuit shown in FIG. 10 during displaying of a frame of an image.

FIG. 12 is a schematic structural diagram of a display panel provided in this disclosure.

FIG. 13 is a schematic structural diagram of an electronic device provided in this disclosure.

### DETAILED DESCRIPTION

The following is preferred embodiments of the present disclosure, and it is noted that several improvements and embellishments can be made by those of ordinary skill in the art without departing from the principle of the present disclosure, which also fall within the protection scope of the present disclosure.

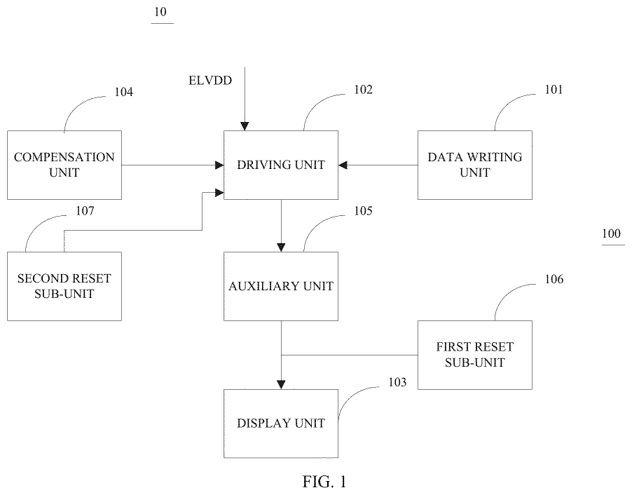

As illustrated in FIG. 1, a first embodiment of this disclosure provides a pixel unit 10, which includes a pixel circuit 100. As illustrated in FIG. 1, the pixel circuit 100 includes a data writing unit 101, a driving unit 102, a display unit 103, a compensation unit 104, and a reset unit (such as 106 or 107 in FIG. 1). During displaying a frame of an image by the pixel circuit, there are three time periods H1-H3 which are arranged sequentially, successively and without an interval. H1 is a reset time period, H2 is a data writing time period, and H3 is a display time period. The data writing time period H2 is later than the reset time period H1 and does not completely overlap therewith, and the display time period H3 is later than the data writing time period H2 and does not completely overlap therewith.

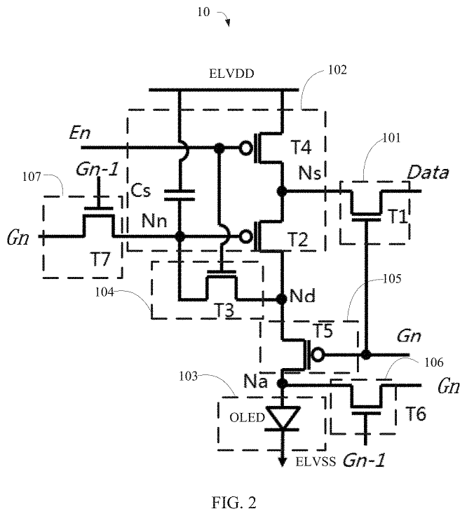

As illustrated in FIGS. 1 to 2, the data writing unit 101 is electrically connected with the driving unit 102 and is operable to write image data Data into the driving unit 102 according to the first scan signal during the data writing time period H2. The first scan signal Gn is provided to the pixel circuit 100 through a scan drive line.

The driving unit 102 is electrically connected with the display unit 103, and is operable to provide, according to a received light emitting signal En along with the image data Data, a driving current to the display unit 103 during the display time period H3, to drive the display unit 103 to emit light and display images.

The compensation unit 104 is electrically connected with the driving unit 102, and is operable to provide a compensation voltage to the driving unit 102 in advance when the image data Data is written into the driving unit 102 during the data writing time period H2. The compensation voltage is used to compensate a voltage drift generated by the driving unit 102 when the driving unit 102 provides the driving current to the display unit 103.

The reset unit is electrically connected with at least one of the display unit 103 and the driving unit 102, and is operable to write, according to a reset signal, a reset voltage into an unit electrically connected with the reset unit 110 during the reset time period H1, so that the unit connected with the reset unit 110 is in a corresponding initial voltage state.

When the reset unit (e.g., 106 in FIG. 1) is only electrically connected with the display unit 103, the reset unit is operable to write the reset voltage into the display unit 103 according to the reset signal during the reset time period H1, so that the display unit 103 is in an initial display voltage state.

When the reset unit (e.g., 107 in FIG. 1) is only electrically connected with the driving unit 102, the reset unit is operable to write the reset voltage into the driving unit 102 according to the reset signal during the reset time period H1, so that the driving unit 102 is in an initial driving voltage state.

When the reset units (such as 106 and 107 in FIG. 1) are electrically connected with the driving unit 102 and the display unit 103 at the same time, the reset units are operable to write the reset voltage into the driving unit 102 and the display unit 103 according to the reset signal during the reset time period H1, so that the driving unit 102 is in the initial driving voltage state and the display unit 103 is in the initial display voltage state.

The reset unit is electrically connected with the scan drive line to receive a scan signal, and is operable to write, according to the reset signal, a scan voltage of the scan signal as the reset voltage into at least one of the display unit 103 and the driving unit 102 during the reset time period H1. The scan signal is the first scan signal or a first scan signal of a next pixel unit 10. The scan signal is provided to the pixel unit 10 through the scan drive line, and the reset voltage of the reset unit is the scan voltage of the scan signal. When the reset voltage is the first scan signal, both the reset voltage and the first scan signal come from the scan drive line. When the reset voltage is the first scan signal of the next pixel unit 10, the reset voltage comes from a scan drive line of the next pixel unit 10. Generally speaking, in this disclosure, there is no need to additionally provide a reset voltage end to provide the reset voltage, and thus there is no extra reset voltage lines to transmit the reset voltage from the reset voltage end to the reset unit, thereby reducing wires in the pixel circuit, saving wire areas, saving space, improving an aperture ratio of the display panel, and making a bezel of the display panel narrower.

In the pixel unit 10 provided in the disclosure, the reset unit is electrically connected with the scan drive line so as to write the scan voltage of the scan signal as the reset voltage into at least one of the display unit 103 and the driving unit 102, so that a unit connected with the reset unit 110 is in the corresponding initial voltage state, which reduces the reset voltage lines, thereby saving wiring space and improving an aperture ratio of the display panel.

In an embodiment, the reset unit 110 includes a first reset sub-unit 106 and a second reset sub-unit 107. The first reset sub-unit 106 is electrically connected with the display unit 103, and operable to write the reset voltage into the display unit 103 according to the reset signal during the reset time period H1, so that the display unit 103 is in the initial display voltage state. The first reset sub-unit 106 is operable to remove currents and voltages remaining in the display unit 103 in a previous display stage, and to ensure that each pixel unit 10 can accurately display the image in a display stage for each frame of an image.

The second reset sub-unit 107 is electrically connected with the driving unit 102, and operable to write the reset voltage into the driving unit 102 according to the reset signal during the reset time period H1, so that the driving unit 102 is in the initial driving voltage state, so as to remove the currents and voltages remaining in the driving unit 102 in the previous display stage and ensure that each pixel unit 10 can accurately display the image in the display stage for each frame of an image.

In an embodiment, the pixel unit 10 further includes an auxiliary unit 105. The auxiliary unit 105 is electrically connected between the display unit 103 and the driving unit 102, and is operable to be in an electrically off state during the data writing time period H2 under control of the first scan signal Gn, so that the display unit 103 is electrically disconnected from the driving unit 102 and the image data Data is prevented from being transmitted to the display unit 103 in a non-display stage to affect a correct image display. Meanwhile, the auxiliary unit 105 is conductive during the display time period H3 under control of the first scan signal Gn, so that the display unit 103 and the driving unit 102 are electrically conductive to transmit the driving current and the image data to the display unit 103 for image display.

Specifically, reference is made to FIG. 2, which is a specific schematic circuit diagram of the pixel unit 10 shown in FIG. 1.

The data writing unit 101 includes a writing transistor T1. The writing transistor T1 has a gate electrically connected with a first scan line Gn, a drain electrically connected with one of data lines, and a source connected with a first node Ns in the driving unit 102. The data line is operable to input image data Data. In this embodiment, the writing transistor T1 is an N-type oxide Thin Film Transistor (TFT). Specifically, the N-type oxide thin film transistor has a channel layer which at least includes one or a combination of: indium gallium zinc oxide, gallium zinc oxide, indium zinc oxide, indium gallium tin oxide, and indium tin oxide. The writing transistor T1, which is the N-type oxide thin film transistor, is operable to receive a high-level scan signal output from the first scan line Gn during the data write time period and be in an on state.

In other embodiments of the present disclosure, the writing transistor T1 may also be a P-type Low Temperature Poly-silicon (LTPS) Thin Film Transistor (TFT). The writing transistor T1, which is the P-type low-temperature poly-silicon thin film transistor, is operable to receive a low-level scan signal output from the first scan line Gn during the data write time period and be in an on state. In this disclosure, the P-type transistor is preferably a P-type low-temperature polycrystalline oxide transistor, and the N-type transistor is preferably an N-type metal oxide transistor.

The driving unit 102 includes a first driving transistor T2, a second driving transistor T4, and a driving capacitor Cs. The first driving transistor T2 has a gate electrically connected with a driving node Nn, a source electrically connected with the first node Ns, and a drain electrically connected with a second node Nd. The driving capacitor Cs is electrically connected with a driving voltage end Vdd and the driving node Nn respectively. The driving voltage end Vdd is operable to provide a light emitting driving voltage ELVDD required by the display unit 103, for example, 4.5-7V.

The second driving transistor T4 has a gate which is electrically connected with a light emitting driving line En to receive a light emitting signal, the second driving transistor T4 has a source which is electrically connected with the driving voltage end Vdd, and the second driving transistor T4 has a drain which is electrically connected with the first node Ns.

In this embodiment, the first driving transistor T2 and the second driving transistor T4 are P-type low-temperature poly-silicon (LTPS) thin film transistors.

In other embodiments of this disclosure, the driving unit 102 only includes the first driving transistor T2 and does not include the second driving transistor T4.

The display unit 103 is an organic light emitting diode (OLED). The OLED has an anode electrically connected with a display node Na, and a cathode electrically connected with a low reference voltage end ELVSS.

The compensation unit 104 includes a compensation transistor T3. The compensation transistor T3 has a gate electrically connected with the light emitting driving line En, a source electrically connected with the driving node Nn, and a drain electrically connected with the second node Nd. In this embodiment, the compensation transistor T3 is an n-type oxide TFT, and the compensation transistor T3 is operable to receive a high-level light emitting signal output from the light emitting driving line En during the data writing time period and be in an on state, so as to store the compensation voltage to the drive node Nn. In other embodiments, the compensation transistor T3 is a P-type low-temperature poly-silicon TFT, and the compensation transistor T3 is operable to receive a low-level light emitting signal output from the light emitting driving line En during the data writing time period and be in an on state. In other embodiments, the compensation unit 104 includes two P-type low-temperature poly-silicon thin film transistors connected in series.

The auxiliary unit 105 includes an auxiliary transistor T5. The auxiliary transistor T5 has a gate electrically connected with the first scan line Gn, a source electrically connected with the second node Nd, and a drain electrically connected with the display node Na. In this embodiment, the auxiliary transistor T5 is a P-type LTPS TFT. The auxiliary transistor T5, which is the P-type LTPS TFT, is operable to receive the low-level scan signal output from the first scan line Gn during the display time period and be in an on state, and to receive the high-level scan signal output from the first scan line Gn during the data writing time period and be in an off state.

The first reset sub-unit 106 includes a first reset transistor T6. The first reset transistor T6 has a gate electrically connected with a second scan line Gn−1, a source electrically connected with the light emitting node Na, and a drain electrically connected with the first scan line Gn. The first scan line Gn provides the scan voltage of the scan signal as the reset voltage. The first reset transistor T6 is operable to be in an on state during the reset time period under control of a scan signal output by the second scan line Gn−1, and is operable to transmit the scan voltage of the scan signal provided by the first scan line Gn, as a reset voltage, to the display unit 103.

The first reset transistor T6 is an N-type oxide thin film transistor or a P-type low-temperature poly-silicon thin film transistor. When the first reset transistor T6 is the N-type oxide thin film transistor, the first reset transistor T6 is operable to be in an on state under control of a high-level scan signal output from the second scan line Gn−1 during the reset time period, and is operable to be in an off state under control of a low-level scan signal output from the second scan line Gn−1 during the data writing time period and the display time period. When the first reset transistor T6 is the P-type low-temperature poly-silicon thin film transistor, the first reset transistor T6 is operable to be in an on state under control of a low-level scan signal output from the second scan line Gn−1 during the reset time period, and is operable to be in an off state under control of a high-level scan signal output from the second scan line Gn−1 during the data writing time period and the display time period.

In this embodiment, the first reset transistor T6 is an N-type oxide TFT.

The second reset sub-unit 107 includes a second reset transistor T7. The second reset transistor T7 has a gate electrically connected with the second scan line Gn−1, a source electrically connected with the driving node Nn, and a drain electrically connected with the first scan line Gn. The first scan line Gn provides the scan voltage of the scan signal as the reset voltage. The second reset transistor T7 is operable to be in an on state during the reset time period under control of a scan signal output by the second scan line Gn−1, and is operable to transmit the scan voltage of the scan signal provided by the first scan line Gn, as a reset voltage, to the display unit.

The second reset transistor T7 is an N-type oxide thin film transistor or a P-type low-temperature poly-silicon thin film transistor.

When the second reset transistor T7 is the N-type oxide thin film transistor, the second reset transistor T7 is operable to be in an on state under control of a high-level scan signal output from the second scan line Gn−1 during the reset time period, and is operable to be in an off state under control of a low-level scan signal output from the second scan line Gn−1 during the data writing time period and the display time period.

When the second reset transistor T7 is the P-type low-temperature poly-silicon thin film transistor, the second reset transistor T7 is operable to be in an on state under control of a low-level scan signal output from the second scan line Gn−1 during the reset time period, and is operable to be in an off state under control of a high-level scan signal output from the second scan line Gn−1 during the data writing time period and the display time period.

In this embodiment, the second reset transistor T7 is an N-type oxide TFT.

The drains of the first reset sub-unit 106 and the second reset sub-unit 107 are both connected with the first scan line Gn, that is, the scan voltage of the scan signal of the first scan line Gn is operable as the reset voltage, so that no extra reset voltage line is needed, the wiring space is saved, and the aperture ratio of the display panel is improved.

The second scan line Gn−1 and the first scan line Gn are two adjacent scan lines, and they output the scan signal during two adjacent scanning periods in turn.

Transistors in the driving unit 102 and auxiliary unit 105 are all P-type TFTs. The source of the P-type TFT can accurately receive the light emitting driving voltage ELVDD with a fixed value, and thus a voltage of the source is unable to be affected by the display unit 103 electrically connected with the drain of the P-type TFT. Meanwhile a turn-on or turn-off of the P-type TFT is determined by a voltage difference between the gate and the source of the P-type TFT. Therefore, when the voltage of the source is determined without being affected by the display unit 103, it can be accurately ensured, with the gate voltage, for respective P-type TFTs in the driving unit 102 and auxiliary unit 105 that leakage currents are not affected by the display unit 103. Then, a drift in the light emitting diode OLED in the display unit 103 will not directly affect voltages at source nodes of the first and second driving transistors T2 and T4 in the driving unit 102 and the driving current, so that the driving current provided to the display unit 103 can be accurately and effectively prevented from drifting due to an influence of the display unit 103, with a better compensation effect. The leakage current refers to a current through the drain at a Vds (drain-source voltage difference) corresponding to a bias setting in which a Vgs, which is defined by a voltage difference between the gate and the source, is shifted by 5V to 10V in a directing opposite to a turn-on direction and with Vth as a reference point.

The data writing unit 101, the compensation unit 104, the first reset sub-unit 106, and the second reset sub-unit 107 all adopt N-type TFT. Therefore, the leakage currents of TFTs in the data writing unit 101, the compensation unit 104, the first reset sub-unit 106, and the second reset sub-unit 107 are small, which can effectively prevent voltages and currents of the first node Ns, the second node Nd, the driving node Nn, and the light emitting node Na from being interfered with, with a good protection. Meanwhile, with the voltages and currents of the aforementioned nodes being protected well, the image data Data can be written and displayed accurately and quickly, that is, the pixel unit can be quickly adapted to a refresh rate at a high or a low speed in displaying different image data. In addition, due to the small leakage currents, the pixel unit 100 can completely match and be adapted to a driving mode with a low power consumption. A refresh rate of the pixel unit 10 of the present disclosure is preferably 1 Hz to 120 Hz. The refresh rate refers to a minimum repetition period of a control signal. In the present disclosure, the refresh rate refers to a frequency of the scan signal or an operating frequency of the pixel circuit. In this disclosure, when the pixel unit provides the driving current to the display unit, the refresh rate of the pixel unit dynamically changes with variation of the frequency of the first scan signal. Preferably, the refresh rate of the pixel unit 10 is 1 Hz to 30 Hz, or 30 Hz to 60 Hz, or 30 Hz to 90 Hz, or 90 Hz to 120 Hz, or 1 Hz to 60 Hz, or 60 Hz to 120 Hz. Preferably, a leakage current of an N-type transistor is less than 10⁻¹² A. Preferably, a metal oxide material which enables the thin film transistor a leakage current of less than 10⁻¹² A is used as a channel layer material of the N-type transistor.

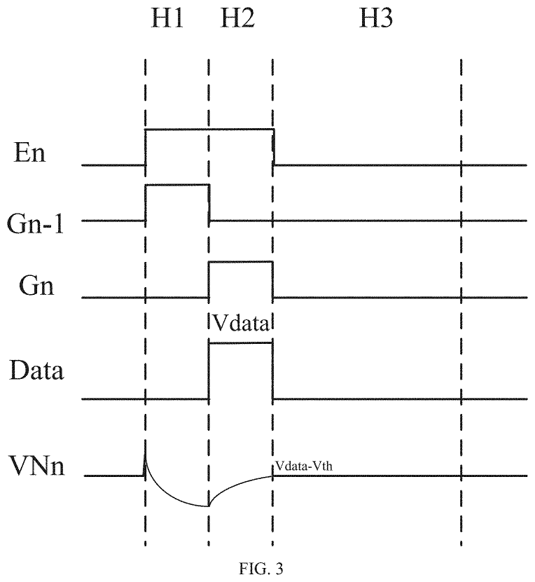

FIG. 3 is a timing diagram of the pixel unit 10 shown in FIG. 2 during displaying of a frame of image, and as illustrated in FIG. 3, a graph corresponding to En is a voltage waveform diagram of the light emitting signal En output on the light emitting driving line En; graphs corresponding to Gn−1 and Gn are waveform diagrams of scan line signals output by the second scan line Gn−1 and the first scan line Gn, respectively; a graph corresponding to Data is a waveform diagram of the image data Data, which is received by the pixel unit 10 and with which an image display is required to be performed, in the frame of image; a graph corresponding to VNn is a voltage waveform diagram for the driving node.

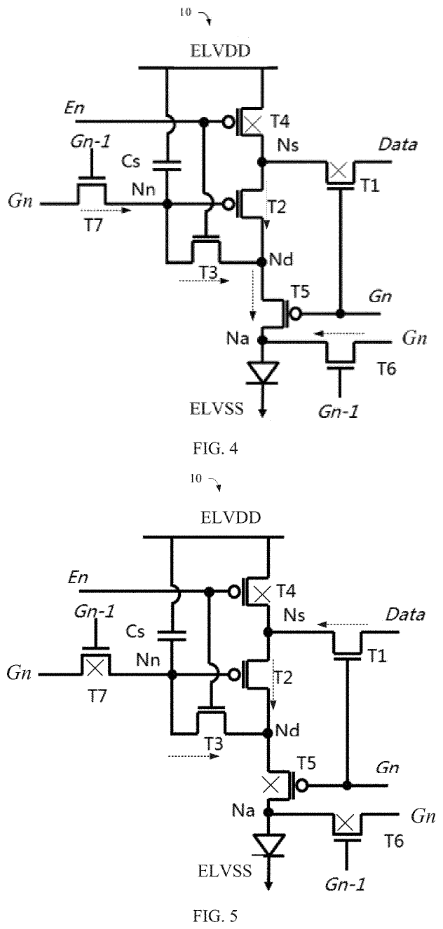

Reference can be made to both FIG. 3 and FIG. 4, FIG. 4 is a schematic diagram of a circuit operating state of the pixel unit 10 shown in FIG. 2 during the reset time period H1.

During the reset time period H1, the light emitting signal En is at a high level, the scan signal Gn−1 is at a high level, and the scan signal Gn is at a low level.

As such, the writing transistor T1 in the data writing unit 101 is operable to be in an off state under control of the low-level scan signal Gn. The second driving transistor T4 in the driving unit 102 is operable to be in an off state under control of the high-level light emitting signal En. The compensation transistor T3 in the compensation unit 104 is operable to be in an on state under control of the high-level light emitting signal En. The auxiliary transistor T5 in the auxiliary unit 105 is operable to be in an on state under control of the low-level scan signal Gn. The first reset transistor T6 in the first reset sub-unit 106 and the second reset transistor T7 in the second reset sub-unit 107 are operable to be in an on state under control of the high-level scan signal Gn−1.

Therefore, a potential of the second node Nd is substantially the same as that of the driving node Nn since the compensation transistor T3 is in an on state, and the auxiliary transistor T5 is operable to be in an on state at the same time, thus the voltage VNn of the driving node Nn will decrease to a low reference voltage. Meanwhile, the first reset transistor T6 is also in an on state, and the scan voltage of the scan signal Gn provided by the first scan line Gn is output to the display node Na as the reset voltage. A voltage VNa of the display node Na decreases from a previous reserved voltage to a low reference voltage.

It is obvious that during the reset time period H1, the voltages of the driving node Nn and the display node Na in the driving unit 102 are both low reference voltages, thus effectively removing the voltages remaining at the driving node Nn and the display node Na during displaying a previous frame of an image, and ensuring that both the driving node Nn and the display node Na are at the initial low reference voltage.

Reference can be made to both FIG. 3 and FIG. 5. FIG. 5 is a schematic diagram of the circuit operating state of the pixel unit 10 shown in FIG. 2 during the data writing time period H2.

During the data writing time period H2, the light emitting signal En continues to be at the high level, the scan signal Gn−1 is at the low level, and the scan signal Gn jumps from the low level to a high level, while the image data Data provides a data voltage Vdata.

Therefore, the writing transistor T1 in the data writing unit 101 is operable in an on state under control of the high-level scan signal Gn, and the data voltage Vdata is transmitted to the first node Ns through the writing transistor T1.

As the voltage VNn of the driving node Nn is a low reference voltage, the low reference voltage loaded on the gate of the first driving transistor T2 in the driving unit 102 is necessarily smaller than the data voltage Vdata loaded on the source, and thus the first driving transistor T2 is in an on state.

The compensation transistor T3 in the compensation unit 104 is in an on state under the control of the high-level light emitting signal En, that is, the source of the compensation transistor T3 is electrically conductive with the drain of the compensation transistor T3, so that the gate and drain of the first driving transistor T2 are directly electrically connected with each other to form a diode connection. At this time, the voltage VNn of the driving node Nn is charged by the data voltage Vdata through the first driving transistor T2. The first driving transistor T2 is operable to be in an off state when the voltage VNn of the driving node Nn is charged to VData−Vth, where Vth is a threshold voltage when the second transistor T2 is turned on. Then the data voltage Vdata stops charging the driving node Nn, and the voltage VNn of the driving node Nn is maintained at VData−Vth due to a non-abrupt characteristic of the driving capacitor Cs. It can be seen that the threshold voltage Vth of the first driving transistor T2 is written to the driving node Nn along with the data voltage Vdata.

The second driving transistor T4 in driving unit 102 is in an off state under the control of the high-level light emitting signal En, the auxiliary transistor T5 in the auxiliary unit 105 is in an off state under the control of the high-level scan signal Gn, and the first reset transistor T6 in first reset sub-unit 106 and the second reset transistor T7 in second reset sub-unit 107 are in an off state under the control of the low-level scan signal Gn−1. Although the scan signal Gn at the drain of the first reset transistor T6 and the scan signal Gn at the drain of the second reset transistor T7 are at a high level, the scan signal Gn−1 transmitted to the gates of the first reset transistor T6 and the second reset transistor T7 is at a low level, and thus the first reset transistor T6 and the second reset transistor T7 are in the off state.

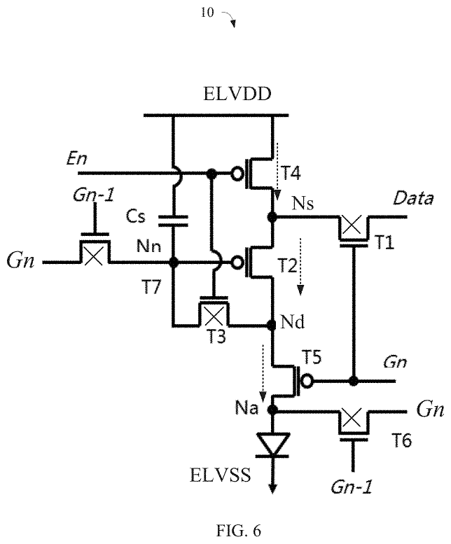

Please refer to both FIG. 3 and FIG. 6, and FIG. 6 is a schematic diagram of the circuit operating state of the pixel unit 10 shown in FIG. 2 during the display time period H3.

During the display time period H3, the light emitting signal En jumps from the high level to a low level, the scan signal Gn−1 continues to be at the low level, the scan signal Gn jumps from the high level to a low level, and the image data Data jumps from the data voltage Vdata to a low level, that is, a writing of the data signal is stopped.

Thereby, the writing transistor T1 in the data writing unit 101 is in an off state under the control of the low-level scan signal Gn.

The second transistor T4 in the driving unit 102 is in the on state under control of the low-level light emitting signal En, so that the light emitting driving voltage ELVDD of the driving voltage end Vdd is transmitted to the first node Ns.

The gate voltage Vdata−Vth (i.e., VNn) in the second transistor T2 is obviously smaller than the light emitting driving voltage ELVDD, and thus the second transistor T2 is in the on state.

The compensation transistor T3 in the compensation unit 104 is in an off state under control of the low-level light emitting signal En, while the auxiliary transistor T5 in the auxiliary unit 105 is in an on state under the control of the low-level scan signal Gn.

As such, the light emitting driving voltage ELVDD is further transmitted to the light emitting diode OLED in the display unit 103 through the second driving transistor T2 and the auxiliary transistor T5.

Meanwhile, the driving current transmitted to the display unit 103 through the second driving transistor T2 is Ids=½k(Vgs−Vth)\hat{ }2, where K=μCox W/L, where W refers to a width of a conductive channel of the second transistor T2, and L refers to a length of the conductive channel, that is, K is a parameter related to conductive channel size, electron mobility and other parameters of the second driving transistor.

Furthermore, Vgs=VNs−VNn=ELVDD−(Vdata−Vth), then Vgs−Vth=ELVDD−(Vdata−Vth)−Vth=ELVDD−Vdata+Vth−Vth=ELVDD−Vdata.

Obviously, the driving current Ids for the light emitting diode OLED in the display unit 103 has nothing to do with the threshold voltage Vth of the first driving transistor T2. That is, by writing, during the data writing time period, the threshold voltage Vth of the first driving transistor T2 to the driving node Nn in advance, the threshold voltage Vth of the first driving transistor T2 is offset during the display time period. Then, a drift in the threshold voltage Vth of the first driving transistor T2 can be compensated and removed, thus avoiding that an emission luminance of the light emitting diode OLED in the display unit 103 cannot reach a correct one due to the drift in the threshold voltage of the first driving transistor T2.

Meanwhile, it also can be ensured that curves with inconsistent brightness, due to different threshold voltages Vth of the first driving transistors T2 in different positions caused by manufacturing processes and use processes, do not occur in display of the display units 103 in all pixel units P in a display area, that is to say, it can be ensured that the display brightness of all pixel units P in the display area is uniform and consistent without being affected by parameters of the first driving transistors T2.

The first reset transistor T6 in the first reset unit 106 and the second reset transistor T7 in the second reset unit 107 are in an off state under control of the scan signal Gn−1 at the low level.

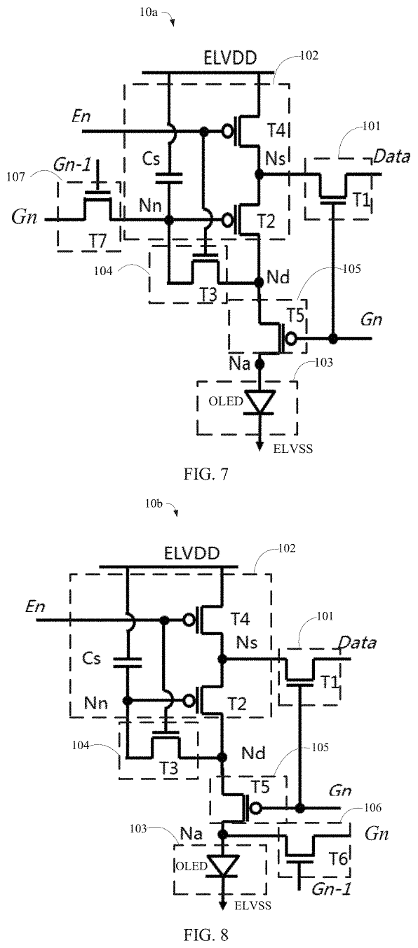

Now reference is made to FIG. 7, which is a schematic circuit diagram of the pixel unit 10a shown in FIG. 2 in a second embodiment of this disclosure. As illustrated in FIG. 7, the circuit structure and operating principle of the pixel unit 10a in this embodiment are basically the same as those of the pixel unit 10 in the first embodiment, except that the pixel unit 10a does not include the first reset sub-unit 106, that is, the pixel unit 10a only includes a data writing unit 101, a driving unit 102, a display unit 103, a compensation unit 104, an auxiliary unit 105, and a second reset sub-unit 107. The second reset sub-unit 107 is connected with the first scan drive line Gn, and the scan voltage of the scan signal is provided by the first scan drive line Gn as the reset voltage.

The specific operating timing and operating process of the pixel unit 10a are basically the same as those of the pixel unit 10, except that the first reset sub-unit 106 does not reset the display node Na to a preset voltage during the reset time period H1 (FIG. 3), while the operating principles and operating timings of other thin film transistors during the respective operating time periods are the same, which will not be described repeatedly in this embodiment.

During the reset time period H1 (FIG. 3), only the second reset sub-unit 107 performs a reset on the driving node Nn. Specifically, the compensation transistor T3 is in the on state, the potential of the second node Nd is substantially the same as that of the driving node Nn, and the auxiliary transistor T5 is in an on state at the same time, thus the voltage VNn of the driving node Nn will decrease to the low reference voltage which is same as the reset voltage.

Meanwhile, The voltage VNa of the display node Na decreases from the previous reserved voltage until the reset time period H1 ends.

Now reference is made to FIG. 8, which is a schematic circuit diagram of the pixel unit 10b shown in FIG. 1 in a third embodiment of this disclosure. As illustrated in FIG. 8, the circuit structure and operating principle of the pixel unit 10b in this example are basically the same as those of the pixel unit 10 in the first embodiment, except that the pixel unit 10b does not include the second reset sub-unit 107, that is, the pixel unit 10b only includes a data writing unit 101, a driving unit 102, a display unit 103, a compensation unit 104, an auxiliary unit 105, and a first reset sub-unit 106. The first reset sub-unit 106 is connected with the first scan drive line Gn, and the scan voltage of the scan signal is provided by the first scan drive line Gn as the reset voltage.

The specific operating timing and operating process of the pixel unit 10b are basically the same as those of the pixel unit 10, except that the second reset sub-unit 107 does not reset the driving node Nn to a preset voltage during the reset time period H1 (FIG. 3), while the operating principles and operating timings of other thin film transistors during the respective operating time periods are the same, which will not be described repeatedly in this embodiment.

During the reset time period H1 (FIG. 3), only the first reset sub-unit 106 performs a reset on the display node Na. Specifically, the compensation transistor T3 is in the on state, the potential of the second node Nd is the same as that of the driving node Nn, and the auxiliary transistor T5 is in an on state, thus the voltage VNn of the driving node Nn decreases from a previous reserved voltage, until the reset time period H1 ends.

Meanwhile, the first reset transistor T6 is in an on state, and the scan voltage of the scan signal Gn provided by the first scan line Gn is output to the display node Na as the reset voltage. A voltage VNa of the display node Na will decrease from a previous reserved voltage, until reaching the low reference voltage which is same as the reset voltage.

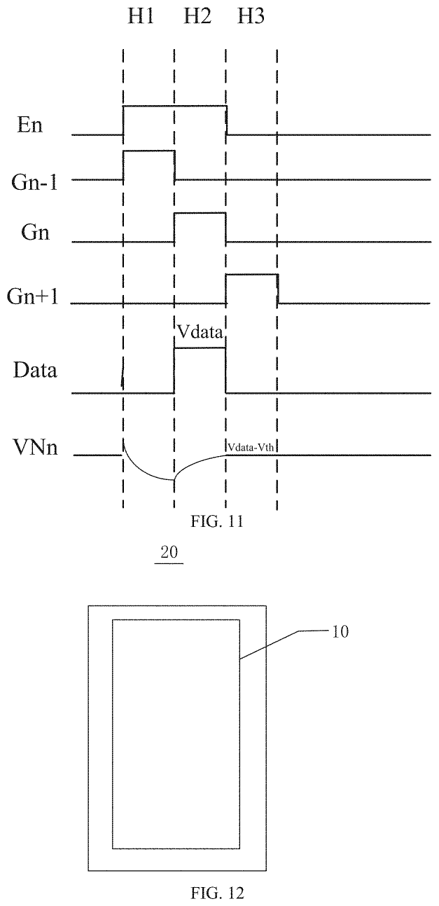

Now reference is made to FIG. 9, which is a schematic circuit diagram of the pixel unit 10c shown in FIG. 1 in a fourth embodiment of this disclosure. As illustrated in FIG. 11, the circuit structure and operating principle of the pixel unit 10c in this example are basically the same as those of the pixel unit 10 in the first embodiment, except that the pixel unit 10c does not include the auxiliary unit 105, that is, the pixel unit 10c only includes a data writing unit 101, a driving unit 102, a display unit 103, a compensation unit 104, a first reset sub-unit 106, and a second reset sub-unit 107.

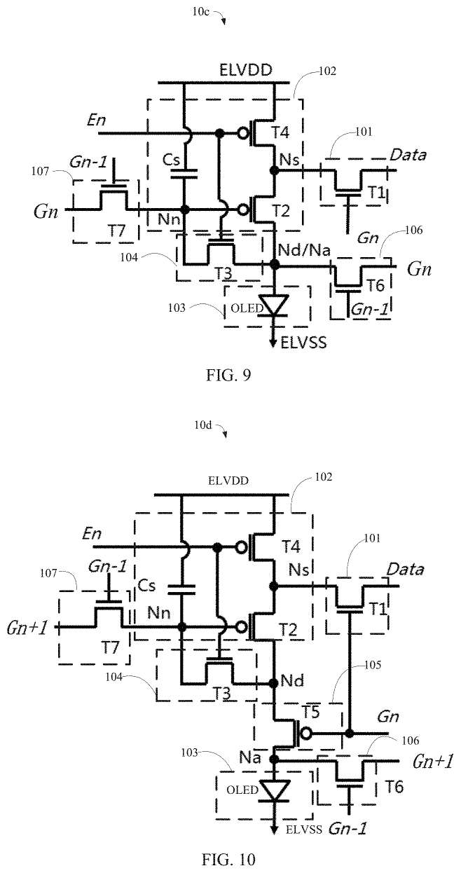

Now reference is made to FIG. 10, which is a schematic circuit diagram of the pixel unit 10d shown in FIG. 1 in a fifth embodiment of this disclosure. As illustrated in FIG. 10, the circuit structure and operating principle of the pixel unit 10d in this example are basically the same as those of the pixel unit 10 in the first embodiment, except that a reset voltage received by the reset unit 110 in the pixel unit 10d is the first scan signal Gn−1 in the next scanning period or the next pixel unit 10, that is, the pixel unit 10d includes a data writing unit 101, a driving unit 102, a display unit 103, a compensation unit 104, an auxiliary unit 105, a first reset sub-unit 106, and a second reset sub-unit 107.

Referring to a timing diagram corresponding to this embodiment and as illustrated in FIG. 11, the specific operating timing and operating process of the pixel unit 10d are basically the same as those of the pixel unit 10, which will not be described repeatedly in this embodiment.

Notably, a mirror circuit of the pixel unit 10 according to this disclosure is also within the protection scope of this disclosure. For example, in FIG. 2, with polarities of all electronic elements changed, those skilled in the art can obtain a corresponding mirror circuit according to this embodiment.

As illustrated in FIG. 12, the present disclosure also provides a display panel 20 which includes a plurality of pixel units 10, for performing an image display, according to any of the embodiments described above located in a display area. In an embodiment, a refresh rate of the display panel 20 is 1 Hz to 120 Hz. The refresh rate refers to a minimum repetition period of a control signal. In the present disclosure, the refresh rate refers to a frequency of the scan signal or an operating frequency of the pixel circuit. For a display panel with a dynamic changing refresh rate from 1 Hz to 120 Hz, the pixel unit 10 of the present disclosure operates stably, and the display of the pixel unit 10 will not be affected by a dynamic change of the refresh rate. Preferably, the refresh rate of the display panel 20 is 1 Hz to 30 Hz, or 30 Hz to 60 Hz, or 30 Hz to 90 Hz, or 90 Hz to 120 Hz, or 1 Hz to 60 Hz, or 60 Hz to 120 Hz.

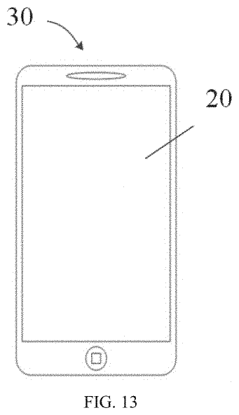

As illustrated in FIG. 13, an electronic device 30 includes the display panel 20 described above. The electronic device 30 can be, but is not limited to, an e-book, a smart phone (such as Android phone, iOS phone, Windows Phone phone, etc.), a tablet computer, a flexible palm computer, a flexible notebook computer, a Mobile Internet Devices (MID) or a wearable device, etc. Or it can be an organic light emitting diode (OLED) electronic device or an active matrix organic light emitting diode (AMOLED) electronic device.

The above embodiments only express several implementations of the present disclosure, and their descriptions are specific and detailed, but they cannot be understood as limiting the scope of the patent of the present disclosure as such. It is noted that several modifications and improvements can be made by those of ordinary skill in the art without departing from the principle of the present disclosure, which also fall within the protection scope of the present disclosure. Therefore, the scope of protection of the patent of the present disclosure shall be subject to appended claims.

What is claimed is:

1. A pixel unit, comprising a pixel circuit, wherein the pixel circuit comprises a data writing unit, a driving unit, a display unit, a compensation unit, and a reset unit, and wherein
the data writing unit is electrically connected with the driving unit and is operable to write image data into the driving unit according to a first scan signal during a data writing time period;
the driving unit is electrically connected with the display unit and is operable to provide, according to a received light emitting signal and the image data, a driving current to the display unit during a display time period, to drive the display unit for image display;
the compensation unit is electrically connected with the driving unit and is operable to provide a compensation voltage to the driving unit in advance when the image data is written into the driving unit, the compensation voltage being used for compensation of a voltage drift generated by the driving unit when the driving unit provides the driving current to the display unit;
the reset unit is electrically connected with at least one of the display unit and the driving unit and is operable to write, according to a reset signal, a reset voltage into an unit electrically connected with the reset unit during a reset time period, so that the unit connected with the reset unit is in a corresponding initial voltage state; and
the reset unit is electrically connected with a scan drive line to receive a scan signal, and is operable to write, according to the reset signal, a scan voltage of the scan signal as the reset voltage into at least one of the display unit and the driving unit during the reset time period, the scan signal being the first scan signal or a first scan signal of a next pixel unit.

2. The pixel unit of claim 1, wherein the reset unit comprises a first reset sub-unit which is electrically connected with the display unit and operable to write the reset voltage into the display unit during the reset time period according to the reset signal so that the display unit is in an initial display voltage state.

3. The pixel unit of claim 1, wherein the reset unit comprises a second reset sub-unit which is electrically connected with the driving unit and operable to write the reset voltage into the driving unit during the reset time period according to the reset signal so that the driving unit is in an initial driving voltage state.

4. The pixel unit of claim 2, wherein
the first reset sub-unit comprise a first reset transistor, the first reset transistor has a gate electrically connected with a second scan line, a source electrically connected with a light emitting node, a drain electrically connected with the scan drive line to receive the scan signal, and the first reset transistor is operable to be in an on state during the reset time period under control of a scan signal output by the second scan line and is operable to transmit the scan voltage of the scan signal provided by the scan drive line, as a reset voltage, to the display unit.

5. The pixel unit of claim 4, wherein the first reset transistor is an N-type oxide thin film transistor or a P-type low-temperature poly-silicon thin film transistor; and
when the first reset transistor is the N-type oxide thin film transistor, the first reset transistor is in an on state under control of a high-level scan signal output from the second scan line during the reset time period, and is in an off state under control of a low-level scan signal output from the second scan line during the data writing time period and the display time period; and
when the first reset transistor is the P-type low-temperature poly-silicon thin film transistor, the first reset transistor is in an on state under control of a low-level scan signal output from the second scan line during the reset time period, and is in an off state under control of a high-level scan signal output from the second scan line during the data writing time period and the display time period.

6. The pixel unit of claim 3, wherein the second reset sub-unit comprises a second reset transistor, wherein the second reset transistor has a gate electrically connected with a second scan line, a source electrically connected with a driving node, and a drain electrically connected with the scan drive line to receive the scan signal, the second reset transistor is operable to be in an on state during the reset time period under control of a scan signal output by the second scan line and is operable to transmit the scan voltage of the scan signal provided by the scan drive line, as a reset voltage, to the display unit.

7. The pixel unit of claim 6, wherein the second reset transistor is an N-type oxide thin film transistor or an P-type low-temperature poly-silicon thin film transistor; and
when the second reset transistor is the N-type oxide thin film transistor, the second reset transistor is in an on state under control of a high-level scan signal output from the second scan line during the reset time period, and is in an off state under control of a low-level scan signal output from the second scan line during the data writing time period and the display time period; and
when the second reset transistor is the P-type low-temperature poly-silicon thin film transistor, the second reset transistor is in an on state under control of a low-level scan signal output from the second scan line during the reset time period, and is in an off state under control of a high-level scan signal output from the second scan line during the data writing time period and the display time period.

8. The pixel unit of claim 1, wherein the driving unit comprises at least one P-type transistor, and the data writing unit and the compensation unit comprise at least one N-type transistor.

9. The pixel unit of claim 8, wherein the data writing time period is later than the reset time period and does not completely overlap the reset time period, and the display time period is later than the data writing time period and does not completely overlap the data writing time period.

10. The pixel unit of claim 9, wherein the driving unit comprises a first driving transistor, a second driving transistor, and a driving capacitor, wherein
the first driving transistor has a gate electrically connected with a driving node, a source electrically connected with a first node, and a drain electrically connected with a second node;
the driving capacitor is electrically connected with a driving voltage end and the driving node respectively, and the driving voltage end is operable for providing a light emitting driving voltage required by the display unit for displaying; and
the second driving transistor has a gate which is electrically connected with a light emitting driving line to receive the light emitting signal, the second driving transistor has a source which is electrically connected with the driving voltage end, and the second driving transistor has a drain which is electrically connected with the first node.

11. The pixel unit of claim 10, wherein the compensation unit comprises a compensation transistor, the compensation transistor has a gate electrically connected with the light emitting driving line, a source electrically connected with the drive node, and a drain electrically connected with the second node; and the compensation transistor is in an on state under control of the light emitting signal during the data writing time period to store the compensation voltage to the drive node.

12. The pixel unit of claim 11, wherein the compensation transistor is an N-type oxide thin film transistor, and the compensation transistor is in an on state when receiving a high-level light emitting signal output from the light emitting driving line during the data writing time period.

13. The pixel unit of claim 11, wherein the compensation unit comprises two P-type low-temperature poly-silicon thin film transistors connected in series.

14. The pixel unit of claim 10, wherein the data writing unit comprises a writing transistor, the writing transistor has a gate electrically connected with a first scan line, a drain electrically connected with one of data lines and operable for receiving the image data, and a source connected with the first node; and the writing transistor is in an on state according to the first scan signal output by the first scan line during the data writing time period to write the image data to the driving node.

15. The pixel unit of claim 14, wherein the writing transistor is an N-type oxide thin film transistor, and the writing transistor is operable to receive a high-level scan signal output from the first scan line during the data writing time period and be in an on state.

16. The pixel unit of claim 14, further comprising an auxiliary unit, wherein the auxiliary unit is electrically connected between the driving unit and the display unit, and is operable to be in an off state during the data writing time period under control of the first scan signal, so that the display unit is electrically disconnected from the driving unit; and the auxiliary unit is operable to be in an on state during the display time period under control of the first scan signal, so that the display unit is electrically conducted with the driving unit and transmits the driving current and the image data to the display unit for image display.

17. The pixel unit of claim 16, wherein the auxiliary unit comprises an auxiliary transistor, the auxiliary transistor has a gate electrically connected with the first scan line, a source electrically connected with the second node, and a drain electrically connected with a display node; and the auxiliary transistor is in an on state according to the first scan signal output by the first scan line during the display time period.

18. The pixel unit of claim 17, wherein the auxiliary transistor is a P-type low-temperature poly-silicon thin film transistor, and the auxiliary transistor is operable to receive a low-level scan signal output from the first scan line to be in an on state during the display time period, and receive a high-level scan signal output from the first scan line during the data writing time period and be in an off state.

19. A display panel, comprising a plurality of pixel units located in a display area for performing an image display, wherein each of the plurality of pixel units comprises a pixel circuit, the pixel circuit comprises a data writing unit, a driving unit, a display unit, a compensation unit, and a reset unit, and wherein the data writing unit is electrically connected with the driving unit and is operable to write image data into the driving unit according to a first scan signal during a data writing time period;
the driving unit is electrically connected with the display unit and is operable to provide, according to a received light emitting signal and the image data, a driving current to the display unit during a display time period, to drive the display unit for image display,
the compensation unit is electrically connected with the driving unit and is operable to provide a compensation voltage to the driving unit in advance when the image data is written into the driving unit, the compensation voltage being used for compensation of a voltage drift generated by the driving unit when the driving unit provides the driving current to the display unit;
the reset unit is electrically connected with at least one of the display unit and the driving unit and is operable to write, according to a reset signal, a reset voltage into an unit electrically connected with the reset unit during a reset time period, so that the unit connected with the reset unit is in a corresponding initial voltage state; and
the reset unit is electrically connected with a scan drive line to receive a scan signal, and is operable to write, according to the reset signal, a scan voltage of the scan signal as the reset voltage into at least one of the display unit and the driving unit during the reset time period, the scan signal being the first scan signal or a first scan signal of a next pixel unit.

20. An electronic device, comprising a display panel, wherein the display panel comprises a plurality of pixel units located in a display area for performing an image display, each of the plurality of pixel units comprises a pixel circuit, the pixel circuit comprises a data writing unit, a driving unit, a display unit, a compensation unit, and a reset unit, and wherein
the data writing unit is electrically connected with the driving unit and is operable to write image data into the driving unit according to a first scan signal during a data writing time period;
the driving unit is electrically connected with the display unit and is operable to provide, according to a received light emitting signal and the image data, a driving current to the display unit during a display time period, to drive the display unit for image display,
the compensation unit is electrically connected with the driving unit and is operable to provide a compensation voltage to the driving unit in advance when the image data is written into the driving unit, the compensation voltage being used for compensation of a voltage drift generated by the driving unit when the driving unit provides the driving current to the display unit;
the reset unit is electrically connected with at least one of the display unit and the driving unit and is operable to write, according to a reset signal, a reset voltage into an unit electrically connected with the reset unit during a reset time period, so that the unit connected with the reset unit is in a corresponding initial voltage state; and
the reset unit is electrically connected with a scan drive line to receive a scan signal, and is operable to write, according to the reset signal, a scan voltage of the scan signal as the reset voltage into at least one of the display unit and the driving unit during the reset time period, the scan signal being the first scan signal or a first scan signal of a next pixel unit.
